(19) United States
(12) Patent Application Publication
(10) Pub. No.: US 2006/0119089 A1
(43) Pub. Date: Jun. 8, 2006

(54) Stabilizing leg apparatus for a trailer

(75) Inventors: David F. Rivers, Wallingford, CT (US); Russell McRoberts, Bremerton, MA (US); Celio J. Gomes, York, ME (US)

Correspondence Address: O'SHEA, GETZ & KOSAKOWSKI, P.C., 1500 MAIN ST., SUITE 912, SPRINGFIELD, MA, 01115, US

(73) Assignee: Patriot Lift Co., LLC, York, ME (US)

(21) Appl. No.: 11/001,970

(22) Filed: Dec. 2, 2004

(51) Int. Cl. B60S 9/02

(52) U.S. Cl. 280/763.1

(57) ABSTRACT

A stabilizing leg apparatus for stabilizing a trailer during the loading or unloading of goods transported by the trailer is provided. The trailer includes a transport container and a wheel assembly coupled to the transport container. The transport container has a front end, a rear end, and an underside having a width extending between a first side and a second side of the container. The wheel assembly is located between a lengthwise midpoint of the container and the rear end of the transport container. The stabilizing leg apparatus includes at least one stabilizing leg and a drive mechanism. The stabilizing leg is mounted adjacent the rear end of the transport container and is selectively operable between a transport position wherein the stabilizing leg does not contact ground and a stabilizing position wherein the stabilizing leg does contact ground. The drive mechanism is configured to move the stabilizing leg from the transport position to the stabilizing position.

### BACKGROUND OF THE INVENTION

1. Field of the Invention

The present invention relates to a stabilizing leg apparatus for a trailer, and more particularly to a stabilizing leg apparatus that can be mounted aft of the trailer wheel assembly or in close proximity to the front end of the trailer.

2. Description of the Prior Art

Many semi-trailers have landing gear for support of the front of the trailer when the tractor is detached. Such landing gears generally have two spaced-apart, jack-type structures joined by a cross-driven shaft engaged to a gear reduction box assembly. The gear reduction box assembly, which typically has two gearing ratios—a low gear and a high gear, may be driven by a manually operated crank. The high gear ratio is for quickly lowering the landing gear to the ground and the low gear ratio is for lifting and supporting the front end of the trailer on the landing gears.

Many devices for the motorized extension and retraction of front landing gear apparatuses for semi-trailers are known. Typical of such devices is U.S. Pat. No. 4,466,637 to Nelson, which discloses an electric motor to drive the usually manually operated crank system for raising and lowering of the semi-trailer landing gear. Pneumatically powered actuators for raising and lowering the semi-trailer's landing gear are disclosed in U.S. Pat. Nos. 4,400,986 and 4,402,526. These patents disclose a complex structure to receive pressurized air for the actuators to rotate the crank shaft of the gear reduction assembly to raise and lower the front landing gear. U.S. Pat. No. 4,345,779 to Busby discloses a pneumatically operated drive unit attached to the shaft of the gear reduction box assembly for raising or lowering a front landing gear. The drive unit uses a pneumatic impact motor. U.S. Pat. No. 3,503,588 to Bach discloses hydraulic pistons for raising and lowering front landing gear. The hydraulic system of Bach is large and cumbersome, and hydraulic pistons do not provide the same positive holding as provided by a gearing arrangement. Power failure or loss of pressure could cause failure and collapse of the landing gear.

U.S. Pat. No. 5,299,829 to Rivers, Jr. et al., which is incorporated herein by reference, discloses an improved front landing gear raising and lowering system using a vane-type pneumatic motor utilizing air from the vehicle's existing air pressure lines that extend to the brakes of the trailer. The invention disclosed in this patent solved many of the prior art shortcomings with respect to the automatic operation of front landing gear on trailers.

Typically the trailer portion of a tractor-trailer rig is uncoupled from the tractor portion during loading and unloading. The trailer is parked adjacent to a loading dock and the contents of the trailer are loaded and unloaded using a tow motor or a conveyor belt mechanism, for example. The heavy weight of the tow motor, the movement of the contents, and/or the uneven removal of the load within the trailer can negatively affect the stability of the trailer. Moreover, in trailers fitted with air-suspended axles, settling of the rear of the trailer, due to loss of air pressure in the suspension or heavy loads being placed in the rear of the trailer, could cause shifting or tilting of the trailer, including misalignment of the front end of the trailer with the loading dock. Thus, in those instances when only the forward part of the trailer is supported by landing gear, the trailer could shift or tilt, possibly becoming unstable.

In addition, most of the landing gear arrangements currently available for supporting the forward portion of the trailer are positioned some distance behind the forward edge of the trailer, and a distance inward from each side of the trailer. As a result, even the front portion of the trailer is not completely stable.

What is needed is an apparatus that increases the stability of the trailer when loading and unloading the trailers and that is easy to operate. Thus, there exists a need for support apparatus that can be located aft of the wheel assembly of the trailer and adjacent the forward edge of the trailer.

### SUMMARY OF THE INVENTION

A stabilizing leg apparatus for stabilizing a trailer during the loading or unloading of goods transported by the trailer is provided. The trailer includes a transport container and a wheel assembly coupled to the transport container. The transport container has a front end, a rear end, a first side, a second side, and an underside. The container has a width that extends between the first side and second side, and between the rear end and the front end. The wheel assembly is located between a midpoint of the transport container and the rear end of the transport container. The stabilizing leg apparatus includes at least one stabilizing leg. The stabilizing leg apparatus is selectively operable between a transport position wherein the stabilizing leg does not contact ground and a stabilizing position wherein the stabilizing leg does contact ground. In one embodiment, the stabilizing leg apparatus mounts adjacent each side of the container aft of the wheel assembly, adjacent the rear end of the trailer.

In another embodiment, the stabilizing leg apparatus mounts on the transport container adjacent the rear end, approximately midway across the width of the transport container.

In still another embodiment, the stabilizing leg apparatus mounts forward of the trailer's landing gear, adjacent the front end of the trailer.

The present invention includes a trailer for transporting goods that has one or more of the stabilizing leg apparatus embodiments described herein.

### BRIEF DESCRIPTION OF THE DRAWINGS

FIG. 1 is a diagrammatic side view of a trailer disengaged from a tractor and having a stabilizing leg apparatus according to one embodiment of the present invention.

FIG. 2 is a diagrammatic end view of the embodiment shown in FIG. 1.

FIG. 3 is a diagrammatic sectional partial view of a stabilizing leg apparatus of the present invention showing a drive mechanism engaged in low gear.

FIG. 4 is a diagrammatic sectional partial view of the stabilizing leg apparatus shown in FIG. 3, now showing the drive mechanism engaged in high gear.

FIG. 5 is a schematic of an embodiment of a pneumatic air system adapted for use with the present invention.

FIG. 6 is a diagrammatic end view of a trailer shown with a stabilizing leg apparatus according to another embodiment of the present invention.

### DETAILED DESCRIPTION OF THE INVENTION

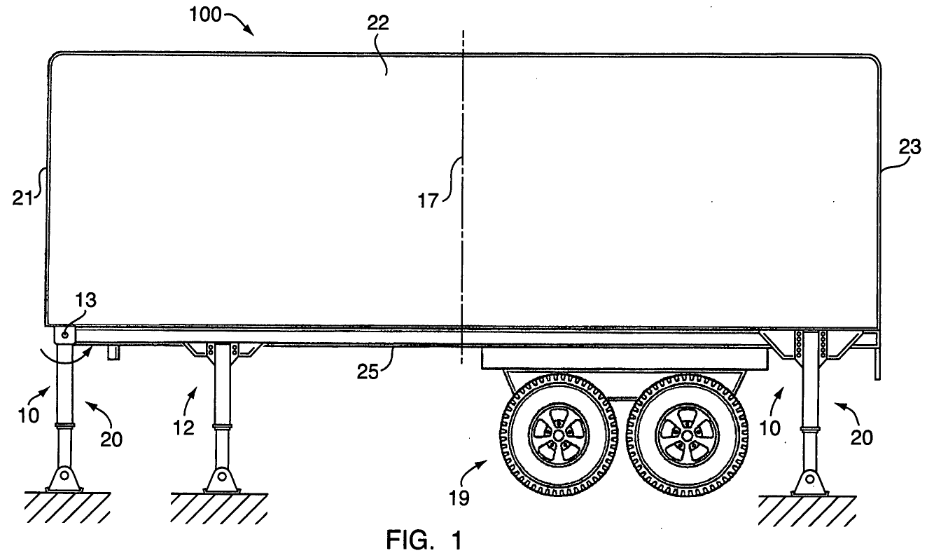

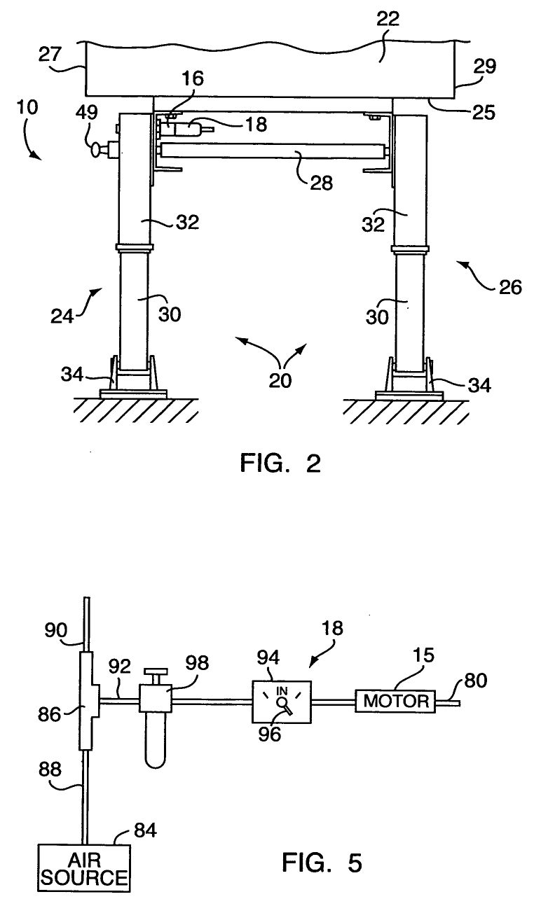

Referring to FIG. 1, a stabilizing leg apparatus 10 for stabilizing a trailer 100 during the loading or unloading of goods transported by the trailer 100 is provided. The trailer 100 includes a wheel assembly 19 and a landing gear 12, both attached to a transport container 22. The transport container 22 has a front end 21, a rear end 23, a first side 27 (see FIG. 2), a second side 29, and an underside 25. The container 22 extends widthwise between the first side 27 and second side 29, and lengthwise between the rear end 23 and the front end 21. The wheel assembly 19 is typically located between a midpoint 17 of the transport container 22 and the rear end 23 of the transport container 22.

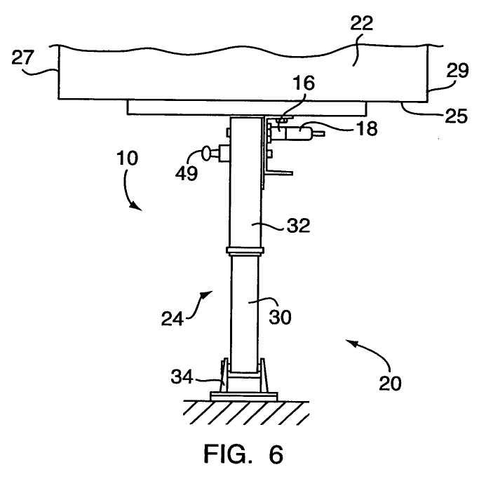

The stabilizing leg apparatus 10 includes at least one stabilizing leg 20, which is mounted on the transport container 22. FIG. 2 shows an embodiment wherein the stabilizing leg apparatus 10 includes a pair of stabilizing legs 20. FIG. 6 shows an embodiment wherein the stabilizing leg apparatus 10 includes a single stabilizing leg 20. The stabilizing leg apparatus 10 is selectively operable between a transport position wherein the stabilizing leg does not contact ground and a stabilizing position wherein the stabilizing leg 20 does contact ground.

In some embodiments, a stabilizing leg apparatus 10 is mounted on the transport container 22 aft of the wheel assembly 19. In other embodiments, a stabilizing leg apparatus 10 is mounted forwards of the trailer landing gear 12, adjacent the front end 21 of the trailer 100. Examples of a stabilizing leg apparatus 10 that is operable to change between a transport position and a stabilizing position include, but are not limited to, one that is retractable within itself, one that is mounted so as to be retractable within the container 22, and one that is mounted so as to be rotatable away from the ground (e.g., pivotable about an axis 13; see FIG. 1).

Referring to FIGS. 1-5, a first embodiment of the stabilizing leg apparatus 10 includes a drive mechanism 14, a motor 16, and a controller 18 operable with respect to vertically extendable and retractable stabilizing legs 20. In some embodiments, a first stabilizing leg 24 is disposed on the driver's side of transport container 22 and a second stabilizing leg 26 is disposed on the passenger's side of transport container 22. The first leg 24 is shown as a “drive” leg and the second leg 26 is shown as a “slave” leg, though the operative roles may be reversed in alternative embodiments envisioned by the present invention. Both legs 24, 26 are extended or retracted through drive leg 24. The second leg 26 is actuated via connecting shaft 28. Accordingly, an operator can operate the entire stabilizing leg apparatus 10 through a drive mechanism 14 mounted to first leg 24.

Each leg 24, 26 includes an inner member 30, an outer member 32, and a base 34. Inner member 30 is telescopically received within outer member 32. Base 34 (e.g., a foot) is connected to the lower end of inner member 30. In operation, inner member 30 may be actuated from within outer member 32. As mentioned above, actuation of first and second legs 24, 26 can be coordinated via connecting shaft 28. The details of the vertical support structure for tractor-trailer landing gear are well known to those skilled in the art and may be applied to the details of the vertical support structure of legs 24, 26. As such, these details are not discussed further herein.

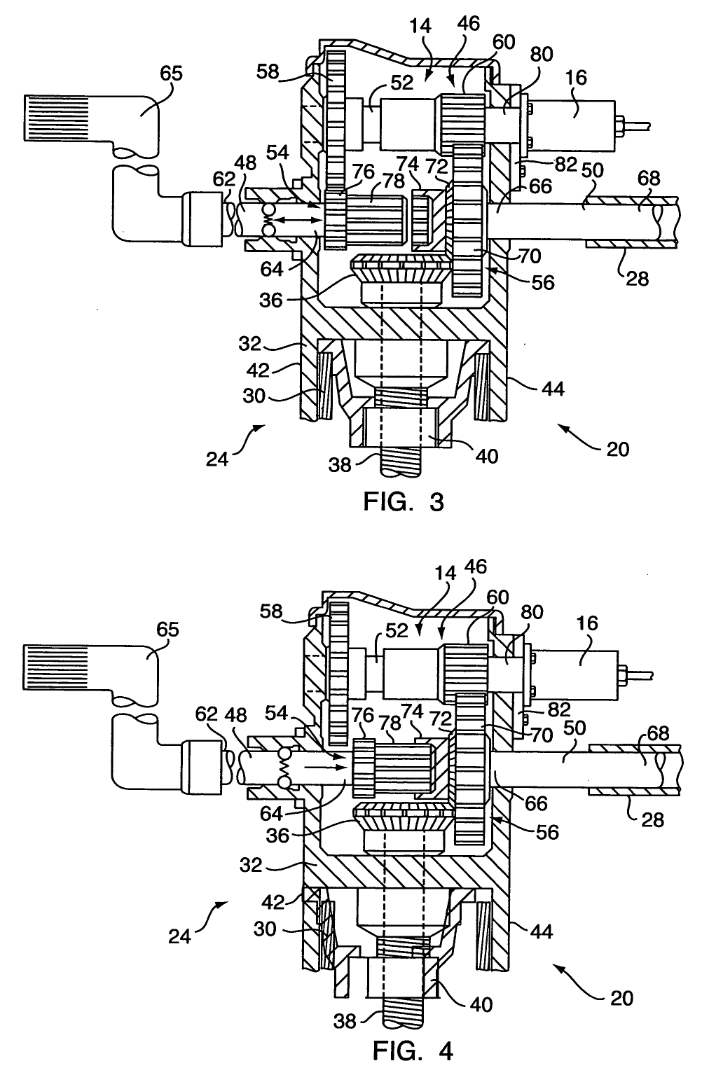

Referring to FIGS. 3 and 4, movement of inner member 30 with respect to outer member 32 is effected by drive mechanism 14. In the embodiment shown, drive mechanism 14 is provided in each leg 24, 26 and includes a bevel gear 36, a threaded shaft 38 and nut 40 pair. Nut 40 is fixed to the upper end of inner member 30 and receives threaded shaft 38, which is vertically disposed within leg 24, 26. Bevel gear 36 is attached to an end of threaded shaft 38. Outer member 32 of drive leg 24 includes a first side 42 and a second side 44. Second side 44 faces slave leg 26. First side 42 faces the opposite direction.

Motor 16 is mounted on second side 44 of outer member 32 of drive leg 24. Motor 16 is attached to a bracket 82 secured to outer member 32. Shaft 80 of the motor (“motor shaft”) is connected to drive mechanism 14. Drive mechanism 14 also includes gear assembly 46, which includes a drive gear 60. Drive gear 60 is mounted on an internal shaft 52. In the embodiment shown in FIGS. 3 and 4, shaft 80 mates directly with internal shaft 52 and drive gear 60, though motor shaft 80 may be connected to drive gear 60 or internal shaft 52 in a variety of ways. In a power-assist mode, operation of motor 16 causes rotation of motor shaft 80, which in turn causes rotation of internal shaft 52 and drive gear 60.

As shown in FIGS. 3 and 4, gear assembly 46 further includes an output gear 56. Output gear 56 includes a spur gear portion 70, a bevel gear portion 72, and a spline portion 74. Bevel gear portion 72 of output gear 56 is engaged with bevel gear 36. Drive mechanism 14 further includes an output shaft 50 and an optional manual input shaft 48. Output gear 56 is attached to output shaft 50.

Drive gear 60 is engaged with spur portion 70 of output gear 56. During power-assist operation, the engagement between drive gear 60 and output gear 56 drives bevel gear 36 and threaded shaft 38 in drive leg 24, thereby extending or retracting drive leg 24. Rotation of output gear 56 also causes rotation of output shaft 50. In the power-assist mode, manual input shaft 48 is non-operational, or in other words, manual input shaft 48 is bypassed.

For manual operation, gear assembly 46 also includes a manual input gear 54 and an intermediate gear 58 mounted on internal shaft 52. Internal shaft 52, shown mounted in outer member 32, extends substantially parallel to manual input shaft 48 and output shaft 50. Output shaft 50 and manual input shaft 48 are mounted within outer member 32 and are axially aligned with one another. Input shaft 48 has a first end 62 and a second end 64. First end 62 of input shaft 48 is adapted to receive a hand crank 65 on first side 42 of outer member 32. Second end 64 of input shaft 48 extends through an opening in first side 42 of outer member 32 and into the interior of outer member 32.

Output shaft 50 also has a first end 66 and a second end 68. Second end 68 of output shaft 50 may be operatively connected to connecting shaft 28 on second side 44 of outer member 32. As shown in FIG. 2, connecting shaft 28 extends over to slave leg 26 such that rotation of output shaft 50 drives connecting shaft 28 to operate the extension mechanism of slave leg 26. First end 66 of output shaft 50 extends through an opening in second side 44 of outer member 32 and into the interior of outer member 32.

Manual input shaft 48 is adapted for axial movement within outer member 32 between a first position (FIG. 3) and a second position (FIG. 4). A manual input gear 54 is attached to input shaft 48 and moves with input shaft 48 both rotationally and axially. Manual input gear 54 includes a spur gear portion 76 and a spline portion 78. In the first position, spur gear portion 76 of manual input gear 54 is engaged with intermediate gear 58 (as will be discussed below) and disengaged from output gear 56. In this position, manual input shaft 48 and output shaft 50 are not directly coupled. In the second position, spur gear portion 76 of manual input gear 54 is disengaged from intermediate gear 58 and spline portion 78 of manual input gear 54 is engaged with spline portion 74 of output gear 56, thereby directly coupling manual input shaft 48 and output shaft 50.

When manual input shaft 48 is in the first position (FIG. 3), wherein manual input gear 54 is engaged with intermediate gear 58, input shaft 48 is indirectly coupled with output shaft 50 via internal shaft 52. In other words, rotation of manual input shaft 48 is transmitted to manual input gear 54, which rotation is in turn transmitted to intermediate gear 58, internal shaft 52 and drive gear 60. Rotation of drive gear 60, in turn, is transmitted to output shaft 50 via output gear 56. The gear ratios between manual input shaft 48 and output shaft 50 are a product of the gears there between; e.g., a low gear when input shaft 48 is directly engaged with output shaft 50, and a high gear when input shaft 48 is indirectly engaged with output shaft 50 via internal shaft 52 and gears 58, 60.

As discussed above, connecting shaft 28 operatively connects output shaft 50 of drive leg 24 to an input shaft of slave leg 26. Slave leg 26 preferably has an extension mechanism that does not require any intermediate shaft or shifting mechanism. For example, the second leg could utilize an input shaft/output gear subassembly and a bevel gear/threaded shaft subassembly similar to those described above to move inner and outer members 30, 32 between retracted and extended positions.

In alternative embodiments, other gear arrangements (e.g., a rack and pinion gear set, a worm gear arrangement, etc.) could be incorporated into drive mechanism 14 to convert rotation of a motor shaft 80 into linear motion so that inner and outer members 30, 32 can be driven between a retracted position and an extended position as will be discussed below.

Motor 16 may be electrical, hydraulic, pneumatic or any other known motor. Indeed, motor 16 could also be an internal combustion engine. However, referring to FIG. 5, motor 16 is preferably a pneumatic gear motor 15 that is powered by an external air source 84. An example of an acceptable commercially available pneumatic gear motor is a WADCO pneumatic gear motor model no. 33MA-220S1 produced by WADCO, a division of Ingersoll-Rand. Preferably, motor 16 is a vane-type rotary driven motor having a gear reduction assembly with an 80-100 to 1 gear reduction ratio.

A variety of air sources 84 can be used to supply pneumatic motor 15. For example, a compressed air storage cylinder could be attached to trailer 100 or transport container 22, or a local source of compressed air, for instance, a source of compressed air at a loading/unloading dock, can be used. Preferably, air source 84 is portable and travels with the tractor-trailer so that it is readily available to operate the support leg apparatus. In a preferred embodiment, compressed air source 84 is the existing air supply from an emergency brake system of the tractor-trailer.

Referring to FIG. 5, a tee-connector 86 is provided on an emergency brake line to provide an airflow from the brake line to pneumatic motor 15. An input airflow line 88 connects tee-connector 86 to air source 84, a first output airflow line 90 connects tee-connector 86 to the emergency brake system of the tractor-trailer, and a second output airflow line 92 connects tee-connector 86 to pneumatic motor 15. Controller 18 is provided between tee connector 86 and motor 16 to control the flow of compressed air to pneumatic motor 15.

In a preferred embodiment, controller 18 includes a valve 94. Valve 94 acts as an air shutoff valve that controls the direction and amount of air pneumatic motor 15 receives. In some embodiments, valve 94 will only provide an airflow to pneumatic motor 15 if valve 94 is manually opened and retained in the open position (e.g., by manually moving a spring-biased lever 96 as shown in FIG. 5). That is, air will be directed to pneumatic motor 15 if the operator moves and holds lever 96. Once lever 96 is returned to an “off” position, the air supply to pneumatic motor 15 will be shut off. If lever 96 is released, the valve will automatically shut off. This prevents the valve from being left in a position where air source 84 is connected only to pneumatic motor 15.

Valve 94 is also preferably a three-position valve that includes an “neutral” position, a first supply position (“down”), and a second supply position (“up”). As noted above, valve 94 is biased to the “neutral” position. Lever 96 enables the operator to move valve 94 between the “neutral” position and either of the first or second supply positions. Valve 94 is connected to pneumatic motor 15 such that air passing through valve 94 when in the first supply position causes pneumatic motor 15 to rotate in a first direction (e.g., clockwise) associated with downwardly extending stabilizing legs 24, 26 (see FIG. 2). Likewise, valve 94 is connected to pneumatic motor 15 such that air passing through valve 94 when its in the second supply position causes pneumatic motor 15 to rotate in a second direction (e.g., counterclockwise) associated with upwardly retracting stabilizing legs 24, 26. The specific directions identified herein are used for illustration purposes only, and the present invention is not intended to prescribe specific directions for specific actions (i.e., clockwise may be used to retract legs 24, 26). Valve 94 may employ one or more air escape ports that utilize mufflers to allow unneeded or excess air to escape.

In alternative embodiments, valve 94 can be a power-assisted type control valve that utilizes one or more solenoids, for example to actuate valve 94 to the first or second positions. Such a power-assisted valve 94 may be configured so that the user operates valve 94 in proximity of valve 94 or at a position remote from valve 94 (e.g., from the cab of the tractor-trailer). Even with such alternative valve designs, however, valve 94 is preferably biased towards the “neutral” position. Pneumatic control valves are known in the art and the operation thereof need not be discussed further herein.

In one embodiment, a lubrication unit 98 (e.g., an automatic oil mist lubricator) is provided upstream of pneumatic motor 15, and more preferably upstream of both motor 15 and valve 94. Lubricator 98 treats the air with a fine oil mist so that valve 94 and motor 15 are lubricated and so that they can operate efficiently. Automatic lubrication units 98 are known in the art and will not, therefore, be further described herein.

As discussed above, stabilizing leg apparatus 10 may be operated in a power-assist mode and in a manual mode. Thus, in one embodiment, an operator could operate a hand crank 65 attachable to a manual input shaft 48 mounted on the drive leg, as shown in FIGS. 3 and 4. The attachment of motor 16 to intermediate shaft 52 does not affect the ability of stabilizing leg apparatus 10 to operate in the manual mode.

When it is desired to manually operate stabilizing legs 24, 26 in the low gear, input shaft 48 is axially moved to a first axial position (FIG. 3). Such outward axial movement causes manual input gear 54 to engage intermediate gear 58, and input shaft 48 to disengage from output shaft 50. As a result, manual input shaft 48 is not directly connected with output shaft 50. Rotation of input shaft 48 causes internal shaft 52 to rotate, and internal shaft 52 causes output shaft 50 to rotate as described above. The rotation of output shaft 50 drives bevel gear 36/threaded shaft 38 to extend or retract leg 24 depending on the direction of rotation of input shaft 48, internal shaft 52 and output shaft 50. When it is desired to manually operate stabilizing legs 24, 26 in the high gear, manual input shaft 48 is axially moved to the second axial position (FIG. 4). Such outward axial movement causes manual input gear 54 to disengage intermediate gear 58, and spline portion 78 of input shaft 48 to engage spline portion 74 of output shaft 50. As a result, manual input shaft 48 is directly connected to output shaft 50. Rotation of manual input shaft 48 causes output shaft 50 to rotate. Once again, the rotation of output shaft 50 drives bevel gear 36 and threaded shaft 38. In the manual operation mode, input shaft 48 is driven by a hand crank 65 attached thereto. Hand crank 65 may be replaced by a knob 49 (FIG. 2) on the first end of input shaft 62 when stabilizing leg apparatus 10 is operated in a power-assist mode.

In those embodiments where the stabilizing leg apparatus 10 includes two stabilizing legs, both legs 20 may be drive legs 24. In this configuration, each leg 24 has its own motor 16 and drive mechanism 14 (within outer member 32), and thus, each leg 24 may be retracted or extended independently of the other. This embodiment may be preferred, for instance, if stability requirements specified individual stabilizing units on each side or if there existed an obstruction underneath trailer 100 that prevented the use of connecting shaft 28.

To actuate the stabilizing leg apparatus 10 in the power-assist operation mode, the operator moves control valve 94 into the supply position designated “down” for extending stabilizing legs 24, 26. In the “down” position, the compressed air powers pneumatic motor 15, which in turn actuates drive mechanism 14. Bevel gear 36 and threaded shaft 38 rotate, thereby causing the respective inner members 30 to move relative to outer members 32 of both drive leg 24 and slave leg 26. Legs 24, 26 extend until bases 34 for each leg 24, 26 contact the ground. Once the desired position of bases 34 is reached, the operator releases valve lever 96 and valve 94 automatically returns to the “neutral” position. When the operator elects to retract stabilizing leg apparatus 10, valve 94 is moved into the supply position designated “up.” In the “up” position, the compressed air powers motor 15 and the attached drive mechanism 14 in the opposite rotational direction as assumed for the “down” direction. As a result, the movement of the bevel gears 36 and threaded shafts 38 of drive and slave legs 24, 26 are reversed and the respective inner members 30 are actuated upwardly within outer members 32 to bring bases 34 clear of the ground. Once a desired position of inner members 30 and bases 34 is reached, the operator releases valve lever 96 and valve 94 automatically returns to the “neutral” position. In those embodiments wherein the stabilizing leg apparatus 10 either retracts within the container 22, or is rotated away from the ground, once the legs 20 are no longer in contact with the ground, the operator is free to either retract the legs 20 further into the container 22 or rotate the legs 20 into a storage position.

If a compressed air source is not available, the present invention can be still used with hand crank 65 and manual input shaft 48, wherein stabilizing legs 24, 26 can be manually extended or retracted as desired in accordance with known practice. Such a capability is helpful in situations where the air source of the tractor-trailer must remain dedicated to the emergency brake line, or is not available.

Although this invention has been shown and described with respect to the detailed embodiments thereof, it will be understood by those skilled in the art that various changes in form and detail thereof may be made without departing from the spirit and scope of the invention.

What is claimed is:

1. A trailer for transporting goods, comprising:
a transport container having a front end, a rear end, an underside that extends widthwise between a first side and a second side of the container, and a lengthwise midpoint;
a wheel assembly coupled to the underside of the transport container, said wheel assembly located between the lengthwise midpoint and the rear end of the transport container; and
a stabilizing leg apparatus having at least one stabilizing leg mounted to the transport container, adjacent the rear end of the transport container, said stabilizing leg being selectively operable between a transport position wherein the stabilizing leg does not contact ground and a stabilizing position wherein the stabilizing leg contacts ground.

2. The trailer of claim 1, wherein the stabilizing leg apparatus includes a pair of stabilizing legs and one of the pair of stabilizing legs is disposed adjacent the first side of the container and the other of the pair of stabilizing legs is disposed adjacent the second side of the container.

3. The trailer of claim 1, wherein the at least one stabilizing leg is a single stabilizing leg, which is mounted approximately midway between the first side and the second side of the transport container to the underside of the transport container.

4. The trailer of claim 1, wherein the stabilizing leg apparatus further includes:
a drive mechanism configured to move the one or more stabilizing legs from the transport position to the stabilizing position;
a motor configured to actuate the drive mechanism, said motor having an output shaft; and
a controller configured to selectively control said motor.

5. The trailer of claim 4, wherein the drive mechanism has a single gear ratio.

6. The trailer of claim 4, wherein the drive mechanism is selectively shiftable between a high gear ratio and a low gear ratio.

7. The trailer of claim 4, wherein the motor is a pneumatic motor, and the controller includes an airflow valve operably connected to the pneumatic motor and which airflow valve is operable to control an amount of air provided to the pneumatic motor.

8. The trailer of claim 7, wherein the airflow valve includes:
a first position configured to provide an airflow to the motor for rotating the output shaft of the motor in a first direction wherein the drive mechanism moves the stabilizing leg from the transport position to the stabilizing position; and
a second position configured to provide an airflow to the motor for rotating the output shaft of the motor in a second direction wherein the drive mechanism moves the stabilizing leg from the stabilizing position to the transport position;
and a third position configured to prohibit an airflow to the motor.

9. The trailer of claim 8, wherein the stabilizing leg apparatus further includes:
an air source supply assembly, wherein the air source supply assembly is configured to operably connect the airflow valve to a pneumatic brake system of a vehicle.

10. The trailer of claim 9, wherein the air source supply assembly includes a tee-connector configured to operably connect to an emergency brake system of the vehicle.

11. The trailer of claim 2, wherein the at least one stabilizing leg is more than one stabilizing leg.

12. The trailer of claim 11, wherein the stabilizing leg apparatus further includes:
one or more drive mechanisms configured to move the stabilizing legs from the transport position to the stabilizing position;
one or more motors configured to actuate the drive mechanisms; and
at least one controller configured to selectively control the motors.

13. The trailer of claim 12, wherein the motors are pneumatic motors, and the controller includes an airflow valve operably connected to the pneumatic motors and configured to control an amount of air provided to the pneumatic motors.

14. The trailer of claim 13, further including an air source supply assembly configured to operably connect the airflow valve to a pneumatic brake system of a vehicle.

15. The trailer of claim 1, wherein the stabilizing leg apparatus further includes at least one stabilizing leg mounted to the transport container, forward of the wheel assembly, adjacent the front end of the transport container.

16. A stabilizing leg apparatus for stabilizing a transport container transported by a vehicle, the transport container having a front end, a rear end, a lengthwise midpoint, an underside that extends widthwise between a first side and a second side and lengthwise between the front end and the rear end, and a wheel assembly coupled to the underside of the transport container, which wheel assembly is located between the lengthwise midpoint and the rear end of the transport container, the stabilizing leg apparatus comprising:
at least one stabilizing leg configured to mount on the transport container aft of the wheel assembly, adjacent the rear end, said stabilizing leg selectively operable between a transport position wherein the stabilizing leg does not contact ground and a stabilizing position wherein the stabilizing leg contacts ground; and
a drive mechanism configured to move the stabilizing leg from the transport position to the stabilizing position.

17. The stabilizing leg apparatus of claim 16, wherein the at least one stabilizing leg includes a pair of stabilizing legs and one of the pair of stabilizing legs is disposed adjacent the first side of the container and the other of the pair of stabilizing legs is disposed adjacent the second side of the container.

18. The stabilizing leg apparatus of claim 16, wherein the at least one stabilizing leg is a single stabilizing leg configured to mount approximately midway across the width of the rear end portion of the transport container to the underside of the transport container.

19. The stabilizing leg apparatus of claim 16, wherein the drive mechanism has a single gear ratio.

20. The stabilizing leg apparatus of claim 16, wherein the drive mechanism is selectively shiftable between a high gear ratio and a low gear ratio.

21. The stabilizing leg apparatus of claim 16, further including a hand crank operatively coupled to the drive mechanism.

22. The stabilizing leg apparatus of claim 16, further including:
a motor configured to actuate the drive mechanism, said motor having an output shaft; and
a controller configured to selectively control the motor.

23. The stabilizing leg apparatus of claim 22, wherein the motor is a pneumatic motor, and the controller includes an airflow valve operably connected to the pneumatic motor and configured to control an amount of air provided to the pneumatic motor.

24. The stabilizing leg apparatus of claim 23, further including;
an air source supply assembly, wherein the air source supply assembly is configured to operably connect the airflow valve to a pneumatic brake system of the vehicle.

25. The stabilizing leg apparatus of claim 24, wherein the air source supply assembly includes a connector configured to operably connect to an emergency brake system of the vehicle.

26. A trailer for transporting goods, comprising:
a transport container having a front end, a rear end, a lengthwise midpoint, and an underside having a width that extends between a first side and a second side of the container;
a wheel assembly coupled to the underside of the transport container, said wheel assembly located on between the lengthwise midpoint and the rear end of the transport container;
a stabilizing leg apparatus including at least one stabilizing leg mounted on the transport container, adjacent the rear end, the stabilizing leg being selectively operable between a transport position wherein the stabilizing leg does not contact ground and a stabilizing position wherein the stabilizing leg contacts ground;
a drive mechanism configured to move the stabilizing leg from the transport position to the stabilizing position;
a pneumatic motor configured to actuate the drive mechanism, the pneumatic motor having a rotating output shaft;
a controller configured to selectively control the pneumatic motor; and
an airflow assembly operatively connected to the controller, wherein the airflow assembly has an airflow line coupled to a connector which is configured to tap into an emergency brake system of a vehicle.

27. A trailer for transporting goods, comprising:
a transport container having a front end, a rear end, and a landing gear assembly;
a wheel assembly coupled to the transport container;
a stabilizing leg apparatus including at least one stabilizing leg mounted on the transport container, forward of the landing gear assembly, and adjacent the front end, the stabilizing leg being selectively operable between a transport position wherein the stabilizing leg does not contact ground and a stabilizing position wherein the stabilizing leg contacts ground;
a drive mechanism configured to move the stabilizing leg from the transport position to the stabilizing position;
a pneumatic motor configured to actuate the drive mechanism, the pneumatic motor having a rotating output shaft;
a controller configured to selectively control the pneumatic motor; and
an airflow assembly operatively connected to the controller, wherein the airflow assembly has an airflow line coupled to a connector which is configured to tap into an emergency brake system of a vehicle.
